(19) United States
(12) Patent Application Publication
(10) Pub. No.: US 2023/0063055 A1
(43) Pub. Date: Mar. 2, 2023

(54) METHOD FOR FINGERPRINT ENROLLMENT, ELECTRONIC DEVICE AND COMPUTER-READABLE STORAGE MEDIUM

(71) Applicant: Egis Technology Inc., Hsinchu City (TW)

(72) Inventors: YU-CHUN CHENG, Hsinchu City (TW); YUAN-LIN CHIANG, Hsinchu City (TW)

(21) Appl. No.: 17/838,036

(22) Filed: Jun. 10, 2022

Related U.S. Application Data
(60) Provisional application No. 63/239,954, filed on Sep. 2, 2021.

(30) Foreign Application Priority Data
Mar. 17, 2022 (CN) 202210263719.9

(51) Int. Cl. G06V 40/50; G06V 10/98; G06V 10/94; G06V 40/60; G06V 40/13

(52) U.S. Cl. CPC G06V 40/50; G06V 10/993; G06V 10/945; G06V 40/67; G06V 40/13

(57) ABSTRACT

A method for fingerprint enrollment according to an embodiment of the present disclosure is adapted to an electronic device including a display and a fingerprint sensor. The method includes displaying a fingerprint enrollment interface on the display, wherein the fingerprint enrollment interface includes a progress indicator, displaying, according to a swipe action of a finger detected by the fingerprint sensor, a growing progress of the progress indicator on the fingerprint enrollment interface, and displaying, in response to the fingerprint sensor detecting that the finger is not removed, the progress indicator in a growing state on the fingerprint enrollment interface to represent that fingerprint information is being collected from the swipe action. According to the method disclosed in the embodiments of the present disclosure, it is possible to guide a user to input more fingerprint information.

### CROSS REFERENCE TO RELATED APPLICATIONS AND CLAIM OF PRIORITY

The present application claims the benefit of U.S. Application No. 63/239,954 filed on Sep. 2, 2021 and Chinese Patent Application No. 202210263719.9 filed on Mar. 17, 2022 at the Chinese Intellectual Property Office, the disclosures of which are incorporated by reference herein in their entirety.

### BACKGROUND

### 1. Technical Field

The present disclosure generally relates to the technical field of fingerprint enrollment. More specifically, the present disclosure relates to a method for fingerprint enrollment, an electronic device and a computer-readable storage medium.

### 2. Background of the Invention

With the continuous development of information technology, fingerprint identification is widely applied in portable electronic devices or access control devices for user identity authentication. To enroll a fingerprint, a user typically needs to press a finger on a fingerprint recognition area one or more times. However, limited fingerprint information can be collected with such fingerprint enrollment methods, which affects a success rate in fingerprint authentication after the user completes enrollment.

### SUMMARY

In view of the above-mentioned technical problems, technical solutions of the present disclosure provide, in various aspects, a method for fingerprint enrollment, an electronic device and a computer-readable storage medium.

In a first aspect of the present disclosure, there is provided a method for fingerprint enrollment adapted to an electronic device including a display and a fingerprint sensor. The method includes: displaying a fingerprint enrollment interface on the display, wherein the fingerprint enrollment interface includes a progress indicator; displaying, according to a swipe action of a finger detected by the fingerprint sensor, a growing progress of the progress indicator on the fingerprint enrollment interface; and displaying, in response to the fingerprint sensor detecting that the finger is not removed, the progress indicator in a growing state on the fingerprint enrollment interface to represent that fingerprint information is being collected from the swipe action.

In an embodiment, the fingerprint enrollment interface includes one or more progress indicators, and the method further includes: determining, according to whether each progress indicator displayed on the fingerprint enrollment interface is in a completed state, whether fingerprint enrollment of the finger is completed.

In another embodiment, the fingerprint enrollment interface further includes a background image displayed beneath the progress indicator; and displaying the progress indicator in the growing state includes: moving, in response to the growing progress of the progress indicator reaching a first preset threshold, the background image in a direction opposite to a growing direction of the progress indicator.

In yet another embodiment, displaying the growing progress of the progress indicator includes: updating, according to a swipe speed or distance of the swipe action, a growing speed or length of the progress indicator displayed on the fingerprint enrollment interface.

In an embodiment, the method further includes judging, in response to the fingerprint sensor detecting that the finger is removed, whether a single swipe action is valid or invalid; and determining, according to whether a single valid swipe action or a plurality of valid swipe actions of each progress indicator meet a preset condition, whether each progress indicator is displayed in a completed state.

In another embodiment, the preset condition includes at least one of: detecting that finger contact time reaches a first preset time length; detecting that swipe distance reaches a first preset distance; quality of the collected fingerprint information meeting a preset standard; or a data amount of the collected fingerprint information reaching a second preset threshold.

In yet another embodiment, the method further includes: displaying, in response to that a single valid swipe action does not meet the preset condition, a prompt message indicating that the swipe action is not completed on the fingerprint enrollment interface to prompt a user to perform more swipe actions.

In an embodiment, judging whether a single swipe action is valid or invalid includes: determining a single swipe action to be invalid in response to detecting any one of: a false touch operation; a finger contact time less than a second preset time length; or a finger contact time greater than or equal to a third preset time length and a swipe distance less than a second preset distance; and otherwise, determining a single swipe action to be valid.

In another embodiment, the fingerprint enrollment interface includes a plurality of progress indicators configured to prompt a user to swipe with different areas of the finger, and the method further includes: sequentially displaying the plurality of progress indicators on the fingerprint enrollment interface in a preset order; and displaying, in response to a current progress indicator in a completed state displayed on the fingerprint enrollment interface, a next progress indicator on the fingerprint enrollment interface.

In yet another embodiment, the fingerprint enrollment interface includes three progress indicators on a left side, in a middle part and on a right side of the fingerprint enrollment interface respectively and configured to prompt the user to perform corresponding swipe actions with a left area, a middle area and a right area of the finger respectively.

In an embodiment, the fingerprint enrollment interface further includes an indication mark, and the method further includes: displaying the indication mark at a forefront end of the progress indicator in the growing direction, to inform a user of a progress position of the progress indicator.

In another embodiment, the progress indicator is displayed as a progress bar.

In yet another embodiment, the fingerprint sensor is disposed at a position including at least one of: beneath a screen of the display; on a long edge of the display; on a short edge of the display; or on a back face of the display.

In a second aspect of the present disclosure, there is provided an electronic device, including: a fingerprint sensor configured to detect a swipe action of a finger; a display configured to display a fingerprint enrollment interface, wherein the fingerprint enrollment interface includes a progress indicator; and a processor connected to the fingerprint sensor and the display, respectively, and configured to: display, according to the swipe action of the finger detected by the fingerprint sensor, a growing progress of the progress indicator on the fingerprint enrollment interface; and display, in response to the fingerprint sensor detecting that the finger is not removed, the progress indicator in a growing state on the fingerprint enrollment interface to represent that fingerprint information is being collected from the swipe action.

In an embodiment, the fingerprint enrollment interface includes one or more progress indicators, and the processor is further configured to: determine, according to whether each progress indicator displayed on the fingerprint enrollment interface is in a completed state, whether fingerprint enrollment of the finger is completed.

In another embodiment, the fingerprint enrollment interface further includes a background image displayed beneath the progress indicator; and the processor is further configured to: move, in response to the growing progress of the progress indicator reaching a first preset threshold, the background image in a direction opposite to a growing direction of the progress indicator.

In yet another embodiment, the processor is further configured to: update, according to a swipe speed or distance of the swipe action, a growing speed or length of the progress indicator displayed on the fingerprint enrollment interface.

In an embodiment, the processor is further configured to judge, in response to the fingerprint sensor detecting that the finger is removed, whether a single swipe action is valid or invalid; and determine, according to whether a single valid swipe action or a plurality of valid swipe actions of each progress indicator meet a preset condition, whether each progress indicator is displayed in a completed state.

In another embodiment, the preset condition includes at least one of: detecting that finger contact time reaches a first preset time length; detecting that swipe distance reaches a first preset distance; quality of the collected fingerprint information meeting a preset standard; or a data amount of the collected fingerprint information reaching a second preset threshold.

In yet another embodiment, the processor is further configured to display, in response to that a single valid swipe action does not meet the preset condition, a prompt message indicating that the swipe action is not completed on the fingerprint enrollment interface to prompt a user to perform more swipe actions.

In an embodiment, the processor is further configured to: determine a single swipe action to be invalid in response to detecting any one of: a false touch operation; a finger contact time less than a second preset time length; or a finger contact time greater than or equal to a third preset time length and a swipe distance less than a second preset distance; and otherwise, determine a single swipe action to be valid.

In another embodiment, the fingerprint enrollment interface includes a plurality of progress indicators configured to prompt a user to swipe with different areas of the finger, and the processor is further configured to: sequentially display the plurality of progress indicators on the fingerprint enrollment interface in a preset order; and display, in response to a current progress indicator in a completed state displayed on the fingerprint enrollment interface, a next progress indicator on the fingerprint enrollment interface.

In yet another embodiment, the fingerprint enrollment interface includes three progress indicators on a left side, in a middle part and on a right side of the fingerprint enrollment interface respectively and configured to prompt the user to perform corresponding swipe actions with a left area, a middle area and a right area of the finger respectively.

In an embodiment, the fingerprint enrollment interface further includes an indication mark, and the display is further configured to: display the indication mark at a forefront end of the progress indicator in the growing direction, to inform a user of a progress position of the progress indicator.

In another embodiment, the progress indicator is displayed as a progress bar.

In yet another embodiment, the fingerprint sensor is disposed at a position including at least one of: beneath a screen of the display; on a long edge of the display; on a short edge of the display; or on a back face of the display.

In a third aspect of the present disclosure, there is provided a computer-readable storage medium storing a program for fingerprint enrollment thereon which, when executed by a processor, causes any method in the first aspect of the present disclosure to be implemented.

Through the above description of technical solutions and embodiments of the present disclosure, those skilled in the art may understand that in the method for fingerprint enrollment of the present disclosure, the progress indicator on the fingerprint enrollment interface is displayed in a growing state, instead of a completed state, when the fingerprint sensor detects that the finger is not removed, and with such setting, it is possible to guide a user to input more fingerprint information, and the input will not be stopped due to the progress indicator presenting a completed state.

### BRIEF DESCRIPTION OF THE DRAWINGS

The above and other objects, features and advantages of exemplary implementations of the present disclosure will become readily understandable by reading the following detailed description with reference to the accompanying drawings. In the accompanying drawings, several implementations of the present disclosure are illustrated by way of example but not limitation, and like or corresponding reference numerals indicate like or corresponding parts, in which:

FIG. 1 is a schematic flowchart of a method for fingerprint enrollment according to an embodiment of the present disclosure;

FIG. 2 is a schematic flowchart of a method for fingerprint enrollment according to another embodiment of the present disclosure;

FIG. 3 is a schematic diagram of displaying a growing progress of a progress indicator according to an embodiment of the present disclosure;

FIG. 4 is a schematic diagram of moving a background image according to an embodiment of the present disclosure;

FIG. 5 is a schematic flowchart of a method including determining whether each progress indicator is displayed in a completed state according to an embodiment of the present disclosure;

FIG. 6 is a schematic flowchart of a method in which a fingerprint enrollment interface including a plurality of progress indicators according to an embodiment of the present disclosure;

FIG. 7 is a schematic diagram of displaying a plurality of progress indicators according to an embodiment of the present disclosure; and

FIG. 8 is a schematic block diagram of an electronic device according to an embodiment of the present disclosure.

### DETAILED DESCRIPTION OF THE INVENTION

The technical solutions in the embodiments of the present disclosure will be described clearly and completely below with reference to the accompanying drawings in the embodiments of the present disclosure. Obviously, the described embodiments are some, but not all, embodiments of the present disclosure. All other embodiments obtained by those skilled in the art based on the embodiments of the present disclosure without paying any creative effort shall be included in the protection scope of the present disclosure.

Aiming at deficiencies in the existing art, the present disclosure provides a completely new and feasible solution. In particular, in the method for fingerprint enrollment of the present disclosure, the progress indicator displayed on the fingerprint enrollment interface can be kept in a growing state before the user's finger leaves the fingerprint sensor, so that it is possible to guide a user to maintain a swipe action for a longer time or longer distance to collect more fingerprint information, which is beneficial to improving the accuracy and reliability in fingerprint authentication or fingerprint identification of the user after the fingerprint enrollment is completed.

As will be appreciated by those skilled in the art in light of the following description, the present disclosure further provides various implementations for further increasing the input amount of fingerprint information in various embodiments. For example, in some embodiments, a growing speed or length of the progress indicator may be updated according to a swipe speed or distance of the swipe action by the user, which is beneficial to guiding the user to input fingerprint information. In other embodiments, a plurality of progress indicators may be provided to prompt the user to swipe with different areas of the finger, which is beneficial to improving the collection range and integrity of the fingerprint information. Hereinafter, specific implementations of the present disclosure will be described in detail with reference to the accompanying drawings.

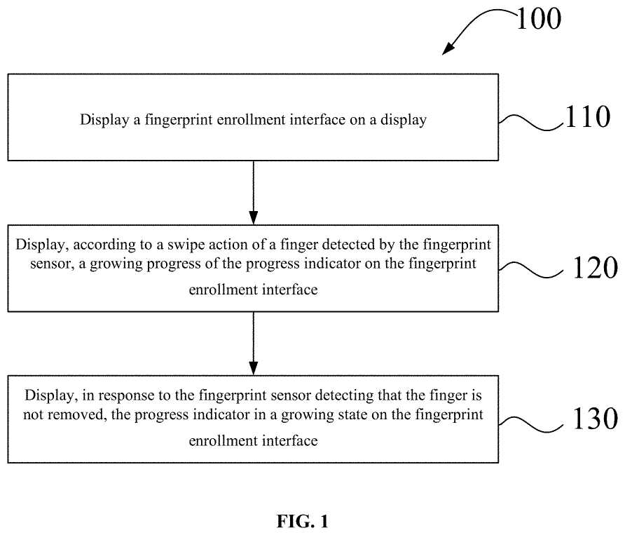

FIG. 1 is a schematic flowchart of a method for fingerprint enrollment according to an embodiment of the present disclosure. As shown in FIG. 1, there is provided a method 100 for fingerprint enrollment adapted to an electronic device including a display and a fingerprint sensor. The method 100 may include steps 110 to 130. In step 110, a fingerprint enrollment interface may be displayed on the display. The fingerprint enrollment interface may include a progress indicator. In some embodiments, the electronic device may include a device such as a cell phone, a computer, a door access, a door lock, or the like. In other embodiments, a fingerprint sensing area of the fingerprint sensor may be arranged in a regular or irregular shape, such as a square, a bar, a circle, a sector, or the like.

In other embodiments, the fingerprint sensor may be disposed at a position including at least one of: beneath a screen of the display; on a long edge of the display; on a short edge of the display; on a back face of the display, or the like. Disposing the fingerprint sensor on the long edge, the short edge, or the back face of the display herein is not limited to direct connection between the fingerprint sensor and the display, but may include a relative positional relationship of the fingerprint sensor to the display. For example, in some application scenarios, the edges and/or the back face of the display may be enclosed by a housing, and the fingerprint sensor may be disposed on the housing over at least one of the long edge, the short edge, or the back face of the display. In some application scenarios, the fingerprint sensor is located beneath the screen of the display so that the user can implement fingerprint input and identification by swiping on the screen. In still other embodiments, the fingerprint sensor may be disposed coplanar with the display, or may be disposed coplanar with an input device such as a keyboard, or the like.

In some embodiments, the fingerprint enrollment interface may be configured to perform information interaction with the user. In an embodiment of the present disclosure, the progress indicator may be configured to represent a progress of the current fingerprint enrollment. In another embodiment, the progress indicator may be displayed as a progress bar. In yet another embodiment, the progress indicator may be displayed in a text form (for example, presenting changes in the progress by a numerical percentage or textual description, or the like) and/or an image form (for example, presenting changes in the progress by changes in color, line, integrity, or the like of an image), or the like. In some embodiments, the fingerprint enrollment interface may include one or more progress indicators.

Next, in step 120, according to a swipe action of a finger detected by the fingerprint sensor, a growing progress of the progress indicator may be displayed on the fingerprint enrollment interface. In some embodiments, the growing progress of the progress indicator may be changed accordingly based on the detected position changes of the finger during the swipe action. In other embodiments, the growing progress may be configured to represent an input amount of fingerprint information. In still other embodiments, in response to that no finger swipe action or finger movement is detected by the fingerprint sensor, the growing progress of the progress indicator may remain unchanged. By displaying the growing progress of the progress indicator, a completion degree of the swipe action, a progress of the fingerprint enrollment or the like can be fed back to the user, which may function to guide the user to input more fingerprint information.

Further, in step 130, in response to the fingerprint sensor detecting that the finger is not removed, the progress indicator may be displayed in the growing state on the fingerprint enrollment interface, to represent that fingerprint information is being collected from the swipe action. In some embodiments, the growing state is an incomplete state. In other embodiments, detecting that the finger is not removed may be understood as detecting that the finger is not removed from the fingerprint sensing area of the fingerprint sensor. By canceling the data amount limit in the single swipe process, the progress indicator can be kept in the growing state, instead of the completed state, when the finger is not removed from the fingerprint sensor, to represent that fingerprint information is being continuously collected from the swipe action, which may guide the user to perform more swipe actions so that more fingerprint information is collected. In still other embodiments, in response to the fingerprint sensor detecting that the finger is removed, it may be determined whether to display the progress indicator in the growing state or the completed state based on an amount of the collected fingerprint information.

In an embodiment of the present disclosure, the method 100 may further include: determining, according to whether each progress indicator displayed on the fingerprint enrollment interface is in a completed state, whether fingerprint enrollment of the finger is completed. For example, in an embodiment, the fingerprint enrollment interface includes one progress indicator, and in response to the progress indicator in the completed state, it is determined that the fingerprint enrollment of the finger is finished. In another embodiment, the fingerprint enrollment interface may include a plurality of progress indicators, and in response to all the progress indicators in the completed state, it is determined that the fingerprint enrollment of the finger is finished. In yet another embodiment, the fingerprint enrollment interface may include a plurality of progress indicators, and displaying the progress indicator in the growing state in step 130 may include: displaying a current progress indicator in the growing state. In an embodiment, in response to the fingerprint sensor detecting that the finger is removed, it may be determined whether to display the current progress indicator in the growing state or the completed state based on an amount of the collected fingerprint information.

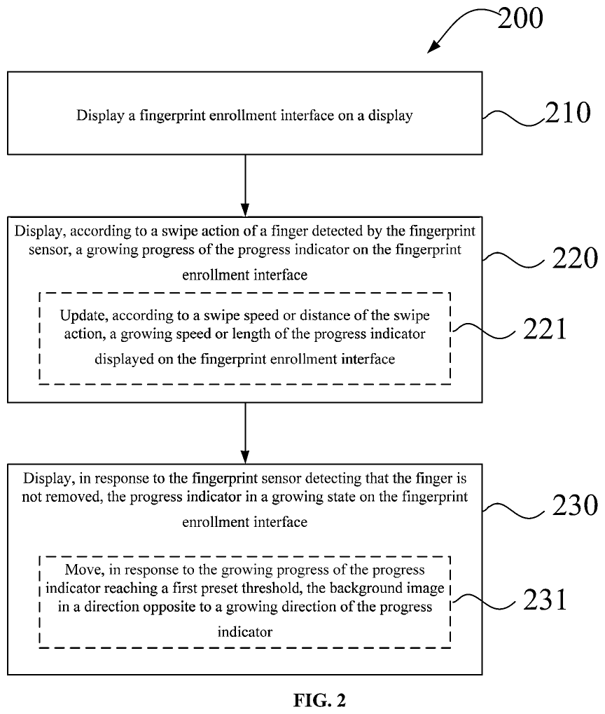

As the method for fingerprint enrollment according to an embodiment of the present disclosure has been exemplarily described above with reference to FIG. 1, it will be appreciated that compared with the method of setting a preset value for the collection amount of fingerprint information and displaying the completed state when the preset value is reached during the swipe process, the method of the present disclosure keeps the progress indicator to be displayed in the growing state when it is detected that the finger is not removed, which is beneficial to collecting a larger amount of fingerprint information, and thereby improving the accuracy and reliability of fingerprint identification. It will also be appreciated that the above description is exemplary but not restrictive. For example, in another embodiment, displaying the growing state of the progress indicator in step 120 may include updating, according to a swipe speed or distance of the swipe action, a growing speed or length of the progress indicator displayed on the fingerprint enrollment interface. The following detailed description is given with reference to FIG. 2.

FIG. 2 is a schematic flowchart of a method for fingerprint enrollment according to another embodiment of the present disclosure. As will be appreciated from the following description, the method 200 shown in FIG. 2 may be an embodied representation of the method 100 shown in FIG. 1, and therefore, the description above in connection with FIG. 1 may be also applicable to the description of the method 200 below.

As shown in FIG. 2, the method 200 may include the following steps 210 to 230. In step 210, a fingerprint enrollment interface may be displayed on a display. The fingerprint enrollment interface may include a progress indicator. Next, in step 220, according to a swipe action of a finger detected by the fingerprint sensor, a growing progress of the progress indicator may be displayed on the fingerprint enrollment interface. In an embodiment of the present disclosure, step 220 may include step 221. In step 221 (shown by a dashed box), according to a swipe speed or distance of the swipe action, a growing speed or length of the progress indicator displayed on the fingerprint enrollment interface may be updated.

For example, in some application scenarios, in response to a higher swipe speed or a longer swipe distance of the swipe action, the progress indicator may have a higher growing speed or a longer growing length, which means that the displayed progress indicator has a faster growing progress. Accordingly, in response to a lower swipe speed or a shorter swipe distance of the swipe action, the progress indicator may have a lower growing speed or a shorter growing length, which means that the displayed progress indicator has a slower growing progress. In other application scenarios, in response to a change in the swipe speed of the swipe action, the growing speed of the progress indicator may be updated accordingly.

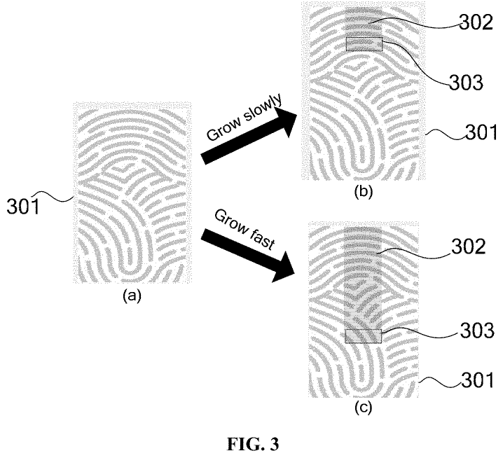

For more ease of understanding, the following exemplary description is provided in conjunction with FIG. 3. FIG. 3 is a schematic diagram of displaying a growing progress of a progress indicator according to an embodiment of the present disclosure. As shown in FIG. 3, before the swipe action, a fingerprint enrollment interface 301 as shown in (a) of FIG. 3 may be displayed on the display, and when the swipe speed of the swipe action is lower and/or the swipe distance is shorter, a progress indicator 302 with a slower growing progress on the fingerprint enrollment interface 301 as shown in (b) of FIG. 3 may be displayed. When the swipe speed of the swipe action is higher and/or the swipe distance is longer, a progress indicator 302 with a faster growing progress on the fingerprint enrollment interface 301 as shown in (c) of FIG. 3 may be displayed.

In another embodiment, the fingerprint enrollment interface 301 may further include an indication mark 303. For example, as shown in (b) and (c) of FIG. 3, the indication mark 303 may be displayed at a forefront end of the progress indicator 302 in a growing direction, to inform a user of a progress position of the progress indicator 302. In some embodiments, the indication mark 303 may be not limited to the square frame form in the figures, but may be in other forms, such as a circle, an ellipse, a line bar, an arrow, text, or the like.

Continuing with the description below returning to FIG. 2, as further shown in FIG. 2, the method 200 may further include step 230, in which in response to the fingerprint sensor detecting that the finger is not removed, the progress indicator may be displayed in the growing state on the fingerprint enrollment interface, to represent that fingerprint information is being collected from the swipe action. In an embodiment of the present disclosure, the fingerprint enrollment interface may further include a background image that may be displayed beneath the progress indicator. In another embodiment, step 230 may include step 231 (shown by a dashed box), in which in response to the growing progress of the progress indicator reaching a first preset threshold, the background image may be moved in a direction opposite to a growing direction of the progress indicator.

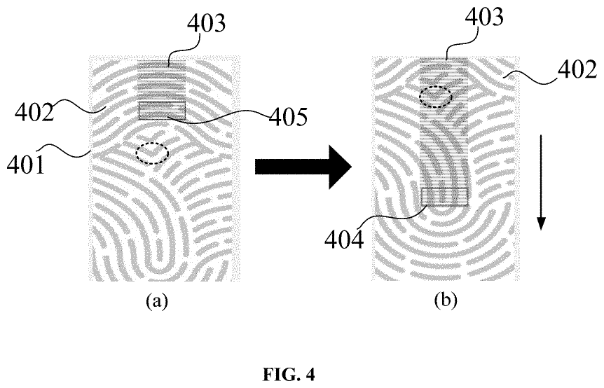

In some embodiments, the background image may include an image of fingerprint content or other content. In some embodiments, the progress indicator may be displayed over the background image, and may cover a portion or all of the background image. In other embodiments, the progress indicator may be displayed over the background image in a translucent manner so that the user can see the content of the background image through the progress indicator. In still other embodiments, in response to the growing progress of the progress indicator reaching a first preset threshold, the current growing progress of the progress indicator may be kept displayed, and the user may have a visual perception that the progress indicator is constantly growing by moving the background image. In another embodiment, in response to the growing progress of the progress indicator reaching a first preset threshold, the background image may be moved while the progress indicator continues to grow, as long as the progress indicator is not displayed in the completed state. For ease of understanding, the following exemplary description is provided in conjunction with FIG. 4.

FIG. 4 is a schematic diagram of moving a background image according to an embodiment of the present disclosure, wherein (a) in FIG. 4 is a schematic diagram of the fingerprint enrollment interface before the background image is moved, and (b) in FIG. 4 is a schematic diagram of the fingerprint enrollment interface after the background image is moved. As shown in (a) of FIG. 4, the fingerprint enrollment interface 401 may include a progress indicator 403 and a background image 402. The background image 402 may be displayed beneath the progress indicator 403. When a swipe action by a finger is detected, a growing progress of the progress indicator 403 as shown in the figure may be displayed on the fingerprint enrollment interface 401.

In an embodiment, in response to the growing progress of the progress indicator 403 reaching a first preset threshold, such as the progress position 404 as shown in (b) of FIG. 4, the background image 402 may be moved in a direction opposite to a growing direction (such as the downward direction indicated by the arrow in the figure) of the progress indicator 403. For example, referring to the position indicated by the dashed circle in the background image 402 shown in (a) of FIG. 4, after the background image 402 is moved, the position may be moved to the position indicated by the dashed circle in (b) of FIG. 4.

In another embodiment, the first preset threshold may be set to the progress position 405 as shown in (a) of FIG. 4, and in response to the growing progress of the progress indicator 403 reaching the first preset threshold, i.e., the position 405, the growing progress of the progress indicator 403 may be continuously updated according to the detected swipe action by the finger, while the background image 402 may be moved upward. For example, a fingerprint enrollment interface 402 as shown in (b) of FIG. 4 may be formed. In other words, the progress indicator 403 may grow to the position 404 but not reach the completed state (such as grow to a lowermost end), while the background image 402 is also moved upward.

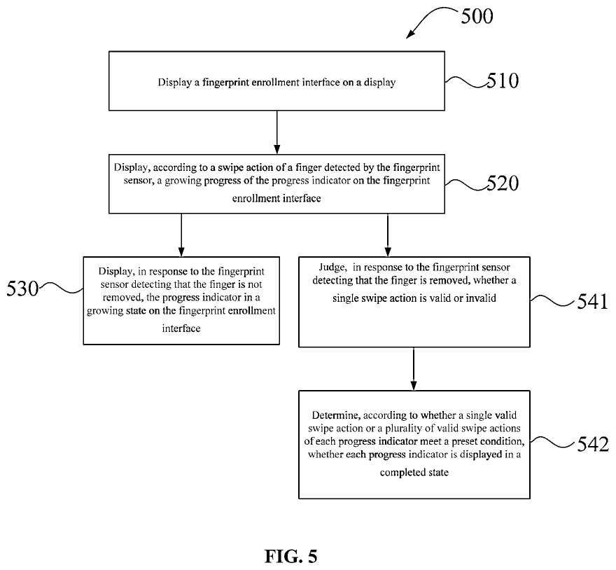

As the method for fingerprint enrollment according to another embodiment of the present disclosure has been described in detail above with reference to FIGS. 2 to 4, it will be appreciated that by moving the background image during the growing process of the progress indicator, the progress indicator can be always displayed in a growing state so that it is possible to guide the user to keep the swipe action as long as possible, thereby obtaining more and more comprehensive fingerprint information. In addition, the above description is exemplary but not restrictive. For example, the method for fingerprint enrollment may be not limited to steps 210, 220 and 230 shown in FIG. 2, but may include further steps such as judging a swipe action after detecting that the finger is removed, to determine a state of the progress indicator. The exemplary description is made below with reference to FIG. 5.

FIG. 5 is a schematic flowchart of a method including determining whether each progress indicator is displayed in a completed state according to an embodiment of the present disclosure. As shown in FIG. 5, the method 500 may include steps 510 to 530. In step 510, a fingerprint enrollment interface may be displayed on a display. The fingerprint enrollment interface may include a progress indicator. Next, in step 520, according to a swipe action of a finger detected by the fingerprint sensor, a growing progress of the progress indicator may be displayed on the fingerprint enrollment interface. Then, the flow may proceed to step 530 in which in response to the fingerprint sensor detecting that the finger is not removed, the progress indicator may be displayed in the growing state on the fingerprint enrollment interface. Steps 510, 520 and 530 have been described in detail in the foregoing with reference to steps 110, 120 and 130 in FIG. 1 and steps 210, 220 and 230 in FIG. 2, and are not repeated here.

As further shown in FIG. 5, the method 500 may further include step 541 in which in response to the fingerprint sensor detecting that the finger is removed, it is judged whether a single swipe action is valid or invalid. In some embodiments, the fingerprint sensor detecting that the finger is removed may include detecting that the finger is removed from (or not in contact with) the fingerprint sensing area of the fingerprint sensor. The single swipe action may be a continuous swipe action in which the finger is kept in contact with the fingerprint sensor. In still other embodiments, a valid swipe action may refer to a swipe action that can collect valid fingerprint information, and an invalid swipe action may refer to a swipe action that cannot collect any fingerprint information or can only collect fingerprint information without any identification significance.

In an embodiment of the present disclosure, judging whether a single swipe action is valid or invalid may include: determining a single swipe action to be invalid in response to detecting any one of: a false touch operation; a finger contact time less than a second preset time length; or a finger contact time greater than or equal to a third preset time length and a swipe distance less than a second preset distance; and otherwise, determining a single swipe action to be valid.

In some embodiments, detecting a false touch operation may include judging whether, for example, the collected fingerprint information before and after is related, continuous, or the like, to determine whether the currently detected operation is a false touch operation. In some application scenarios, if it is detected that the finger contacts the fingerprint sensor or the screen of the display for a too short time, or a press has a too long residence time but no movement, or the finger swipe lasts for a too short time, or the like, typically an accidental operation by the user is present. In this case, it may judge whether there is a false operation by detecting the finger contact time, the swipe distance, or the like, and comparing the finger contact time, the swipe distance, or the like with preset parameters such as a second preset time length, a third preset time length, a second preset distance, or the like. Through the above judgment, potential invalid swipe actions can be effectively excluded so that valid swipe actions can be determined and subsequent operations can be performed. In still other embodiments, the method 500 may further include a step in which in response to a single swipe action being invalid, a prompt message of swipe error may be displayed on the fingerprint enrollment interface.

Next, in step 542, according to whether a single valid swipe action or a plurality of valid swipe actions of each progress indicator meet a preset condition, it may be determined whether each progress indicator is displayed in a completed state. When a single swipe action is determined to be valid, the single swipe action may be further used to determine the state of the progress indicator. In some embodiments, the method 500 may further include a step in which in response to determining that the current progress indicator is displayed in the completed state, a prompt message of swipe completed may be displayed on the fingerprint enrollment interface. In other embodiments, the method 500 may further include a step in which in response to determining that all progress indicators on the fingerprint enrollment interface are displayed in the completed state, a prompt message of enrollment completed may be displayed.

In another embodiment of the present disclosure, the preset condition may include at least one of: detecting that finger contact time reaches a first preset time length; detecting that swipe distance reaches a first preset distance; quality of the collected fingerprint information meeting a preset standard; or a data amount of the collected fingerprint information reaching a second preset threshold. In a specific embodiment, the first preset distance may be set to, for example, 1 cm, and then in step 542, when a single valid swipe action or a plurality of valid swipe actions of the current progress indicator reaches or cumulatively reach (e.g., equal to or greater than) 1 cm, it may be determined that the current progress indicator is displayed in the completed state.

In some application scenarios, when the collected fingerprint image is blurred, the quality of the fingerprint information may not meet a preset standard, making it impossible to identify the accurate fingerprint information. The preset standard may be a fingerprint quality standard sufficient for fingerprint identification. Furthermore, by setting the second preset threshold, it is ensured that fingerprint information of a certain range, instead of merely one position, of the finger can be collected, which is beneficial to improving the accuracy of fingerprint identification and authentication after successful enrollment, reducing the misjudgment rate, and the like.

In some embodiments, meeting the preset condition may include meeting any one of the preset conditions or meeting a plurality of the preset conditions at the same time. In other embodiments, meeting the preset condition may include prioritizing a plurality of preset conditions to make judgments according to priorities of the plurality of preset conditions. If a preset condition of a higher priority is met, there is no need to judge whether another preset condition of a lower priority is met. In still other embodiments, meeting the preset condition may include assigning, according to importance of the plurality of preset conditions, a weight to each of the plurality of preset conditions, to determine whether each progress indicator is displayed in the completed state according to a weighted average of judgment results of the plurality of preset conditions.

In another embodiment, the method 500 may further include a step in which in response to that a single valid swipe action does not meet the preset condition, a prompt message of swipe incomplete may be displayed on the fingerprint enrollment interface to prompt a user to perform more swipe actions so that whether the current progress indicator is displayed in the completed state can be determined according to whether an accumulative result of a plurality of valid swipe actions meets the preset condition. The prompt message described herein may be displayed in the form of text, an image, animation, a video, rendering, or the like.

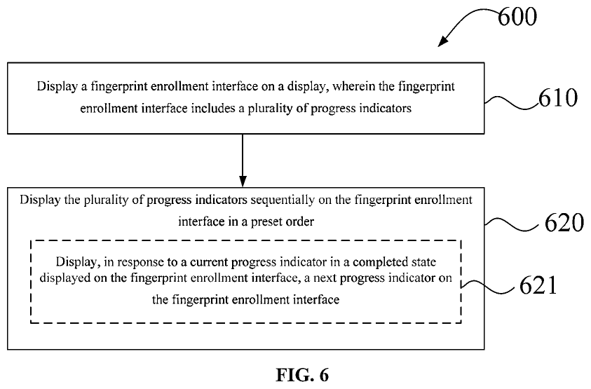

As the step of determining whether the progress indicator is displayed in the completed state according to an embodiment of the present disclosure has been described in detail above with reference to FIG. 5, it will be appreciated that by implementing step 530, the collected data amount in a single swipe action can be effectively increased so that in combination with steps 541 and 542, a count of swipe actions of each progress indicator can be effectively controlled, and fingerprint enrollment can be completed without frequent swipe actions, thereby facilitating improvement of the user experience. For example, in some specific implementations, by performing the method 500 of the present embodiment, it is possible to complete the progress of a single progress indicator while controlling the count of valid swipe actions of each progress indicator to be only 1 or 2. The case where the fingerprint enrollment interface includes a plurality of progress indicators will be exemplarily described below with reference to FIG. 6.

FIG. 6 is a schematic flowchart of a method in which a fingerprint enrollment interface including a plurality of progress indicators according to an embodiment of the present disclosure. As will be appreciated from the following description, the method 600 may be an embodied representation of the method 100 described above in conjunction with FIG. 1, the method 200 described above in conjunction with FIG. 2, and the method 500 described above in conjunction with FIG. 5, and therefore, the description of the method 100, the method 200, and the method 500 may be equally applicable to the method 600 below.

As shown in FIG. 6, the method 600 may include the following steps 610 to 620. In step 610, a fingerprint enrollment interface may be displayed on a display. The fingerprint enrollment interface may include a plurality of progress indicators configured to prompt a user to swipe with different areas of the finger. The plurality of progress indicators may be located at different positions of the fingerprint enrollment interface. The plurality of progress indicators may be connected with each other or arranged at intervals. The plurality of progress indicators may have a same size or different sizes. The plurality of progress indicators may have a same shape or different shapes. The arrangement of the plurality of progress indicators is beneficial to collecting more comprehensive and complete fingerprint information of the finger.

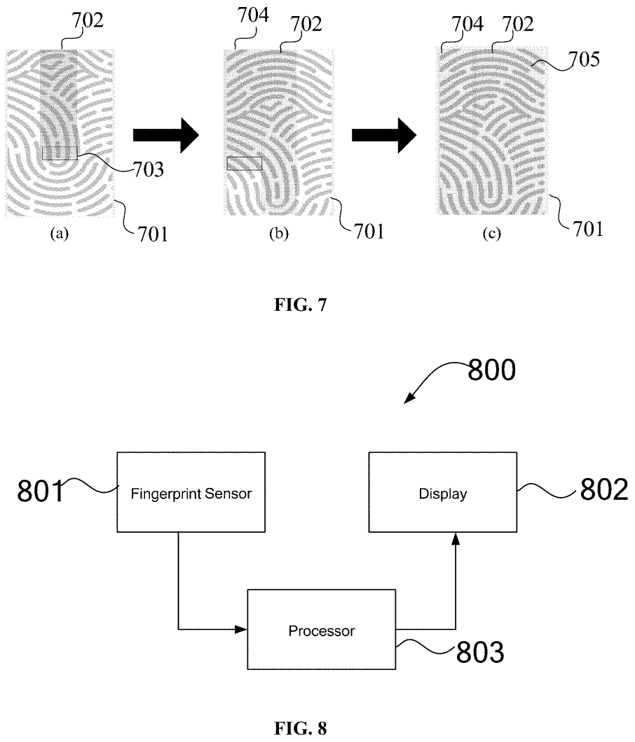

Furthermore, the plurality of progress indicators may be displayed according to step 620. For example, the plurality of progress indicators may be sequentially displayed on the fingerprint enrollment interface in a preset order. With such setting, the user may be guided to perform swipe actions with different areas of the finger in a preset order. In an embodiment, step 620 may include step 621 (shown by a dashed box), in which in response to a current progress indicator in a completed state displayed on the fingerprint enrollment interface, a next progress indicator may be displayed on the fingerprint enrollment interface. For ease of understanding, the following exemplary illustration is provided in conjunction with FIG. 7.

FIG. 7 is a schematic diagram of displaying a plurality of progress indicators according to an embodiment of the present disclosure. As shown in (a) of FIG. 7, the fingerprint enrollment interface 701 may include a first progress indicator 702, which may be a progress bar and may be located in a middle part of the fingerprint enrollment interface 701. In an embodiment, a indication mark 703 may be displayed at a forefront end of the first progress indicator 702 in the growing direction, to inform a user of a progress position of the first progress indicator 702. The growing progress of the first progress indicator 702 may be the same as or similar to that in steps 120 and 130 described in conjunction with FIG. 1, steps 220 and 230 described in conjunction with FIG. 2, and steps 520, 530, 541, and 542 described in conjunction with FIG. 5, and will not be repeated here.

Next, as the first progress indicator 702 grows (or the progress accumulates), in response to the first progress indicator 702 in a completed state, for example, as shown in (b) of FIG. 7, the first progress indicator 702 grows to a bottom position (e.g., into the completed state), and a next progress indicator (such as a second progress indicator 704 as shown in (b) of FIG. 7) may be displayed. The second progress indicator 704 may be a progress bar and may be located on a left side of the fingerprint enrollment interface 701.

Further, as shown in (c) of FIG. 7, as the second progress indicator 704 grows, in response to the second progress indicator 704 growing to the shown bottom position (e.g., into the completed state), a third progress indicator 705 may be displayed. The fingerprint enrollment may be completed when the third progress indicator 705 is in the completed state, and then a prompt message of fingerprint enrollment completed may be displayed. The third progress indicator 705 may be a progress bar and may be located on a right side of the fingerprint enrollment interface 701.

In this embodiment, the fingerprint enrollment interface 701 may include three progress indicators 702, 704 and 705, which may be located in a middle part, on a left side, and on a right side of the fingerprint enrollment interface 701 respectively and configured to prompt the user to perform corresponding swipe actions with a middle area, a left area and a right area of the finger respectively. Such partition setting can better conform to a somatosensory swipe habit, and in combination with controlling the count of valid swipe actions of each progress indicator, a total count of valid swipe actions required to complete the enrollment can be controlled within a reasonable range. For example, in an embodiment, it may be controlled such that one or two valid swipe actions are required to complete one progress indicator, and for three progress indicators, the fingerprint enrollment may be completed within 3 to 6 valid swipe actions, which is beneficial to reducing the total count of swipe actions, and thereby to improving the enrollment efficiency as well as the use experience.

The technical solution including a plurality of progress indicators according to the embodiment of the present disclosure has been exemplarily described above with reference to FIGS. 6 and 7, but it will be appreciated that the above description is merely illustrative and not restrictive. For example, the count of progress indicators may be not limited to three as shown in FIG. 7, but may be set to be more or less as needed. The plurality of progress indicators may be not limited to the arrangement in close vicinity shown in FIG. 7, but may be provided at intervals or in an intersected manner as needed. For another example, the plurality of progress indicators may be not limited to be displayed in the shown order, but may be displayed sequentially in order of, for example, the left side, the middle part, and the right side. The plurality of progress indicators may be not limited to the form of the shown progress bar, but may be set to be displayed in other forms as needed.

FIG. 8 is a schematic block diagram of an electronic device according to an embodiment of the present disclosure. As shown in FIG. 8, the electronic device 800 may include: a fingerprint sensor 801 configured to detect a swipe action of a finger; a display 802 configured to display a fingerprint enrollment interface, wherein the fingerprint enrollment interface includes a progress indicator; and a processor 803 connected to the fingerprint sensor 801 and the display 802, respectively, and configured to: display, according to the swipe action of the finger detected by the fingerprint sensor 801, a growing progress of the progress indicator on the fingerprint enrollment interface; and display, in response to the fingerprint sensor 801 detecting that the finger is not removed, the progress indicator in a growing state on the fingerprint enrollment interface to represent that fingerprint information is being collected from the swipe action.

In an embodiment, the fingerprint enrollment interface may include one or more progress indicators, and the processor 803 may be further configured to: determine, according to whether each progress indicator displayed on the fingerprint enrollment interface is in a completed state, whether fingerprint enrollment of the finger is completed.

In another embodiment, the fingerprint enrollment interface may further include a background image that may be displayed beneath the progress indicator; and the processor 803 may be further configured to: move, in response to the growing progress of the progress indicator reaching a first preset threshold, the background image in a direction opposite to a growing direction of the progress indicator.

In yet another embodiment, the processor 803 may be further configured to: update, according to a swipe speed or distance of the swipe action, a growing speed or length of the progress indicator displayed on the fingerprint enrollment interface.

In an embodiment, the processor 803 may be further configured to judge, in response to the fingerprint sensor 801 detecting that the finger is removed, whether a single swipe action is valid or invalid; and determine, according to whether a single valid swipe action or a plurality of valid swipe actions of each progress indicator meet a preset condition, whether each progress indicator is displayed in a completed state.

In another embodiment, the preset condition may include at least one of: detecting that finger contact time reaches a first preset time length; detecting that swipe distance reaches a first preset distance; quality of the collected fingerprint information meeting a preset standard; or a data amount of the collected fingerprint information reaching a second preset threshold.

In yet another embodiment, the processor 803 may be further configured to display, in response to that a single valid swipe action does not meet the preset condition, a prompt message indicating that the swipe action is not completed on the fingerprint enrollment interface to prompt a user to perform more swipe actions.

In an embodiment, the processor 803 may be further configured to: determine a single swipe action to be invalid in response to detecting any one of: a false touch operation; a finger contact time less than a second preset time length; or a finger contact time greater than or equal to a third preset time length and a swipe distance less than a second preset distance; and otherwise, determine a single swipe action to be valid.

In another embodiment, the fingerprint enrollment interface may include a plurality of progress indicators configured to prompt a user to swipe with different areas of the finger, and the processor 803 may be further configured to: sequentially display the plurality of progress indicators on the fingerprint enrollment interface in a preset order; and display, in response to a current progress indicator in a completed state displayed on the fingerprint enrollment interface, a next progress indicator on the fingerprint enrollment interface.

In yet another embodiment, the fingerprint enrollment interface may include three progress indicators on a left side, in a middle part and on a right side of the fingerprint enrollment interface respectively and configured to prompt the user to perform corresponding swipe actions with a left area, a middle area and a right area of the finger respectively.

In an embodiment, the fingerprint enrollment interface may further include an indication mark, and the display 802 may be further configured to: display the indication mark at a forefront end of the progress indicator in the growing direction, to inform a user of a progress position of the progress indicator.

In another embodiment, the progress indicator may be displayed as a progress bar.

In yet another embodiment, the fingerprint sensor 801 may be disposed at a position including at least one of: beneath a screen of the display 802; on a long edge of the display 802; on a short edge of the display 802; or on a back face of the display 802.

The electronic device in the implementations of the present disclosure has been described and explained in detail in the foregoing with reference to the method, and will not be repeated here.

Through the description of the above implementations, those skilled in the art can clearly understand that the implementations may be implemented by means of software plus a necessary general hardware platform. Obviously, it may also be implemented by hardware. Those of ordinary skill in the art will understand that: all or a portion of the steps for implementing the method embodiments described above in connection with FIGS. 1 to 7 may be performed by hardware associated with program instructions, which may be stored in a computer-readable storage medium, and which, when executed, may cause steps including the method embodiments described above to be implemented.

The computer-readable storage medium may be, but is not limited to, an electronic, magnetic, optical, electromagnetic, infrared, or semiconductor system, apparatus, or device, or any combination thereof. More specific examples (a non-exhaustive list) of the readable storage medium include: an electrical connection having one or more wires, a portable disk, a hard disk, a random access memory (RAM), a read-only memory (ROM), an erasable programmable read-only memory (EPROM or flash), an optical fiber, a portable compact disk read-only memory (CD-ROM), a static RAM (SRAM), a digital versatile disk (DVD), an optical storage device, a magnetic storage device, or any suitable combination thereof. Any such computer storage media may be part of a device, or accessible or connectable to the device. Any application or unit described in the present disclosure may be implemented using computer-readable/executable instructions that may be stored or otherwise held by such computer-readable media.

Through the above description of the technical solutions and embodiments of the method for fingerprint enrollment and the electronic device of the present disclosure, those skilled in the art will appreciate that in the method for fingerprint enrollment of the present disclosure, the progress indicator can be kept to be displayed in the growing state, instead of the completed state, when it is detected that the finger is not removed from the fingerprint sensor, so that more fingerprint information can be collected, which is beneficial to improving the accuracy of fingerprint recognition and reducing the misjudgment rate of fingerprint authentication. In some embodiments, the displayed growing speed or length of the progress indicator may be updated according to a swipe speed or distance of the swipe action, so that the user can obtain effective feedback in the finger swipe, and the willingness of the user to continuously input more fingerprint information is improved. In other embodiments, by providing a plurality of progress indicators, the swipe actions required to complete the fingerprint enrollment can be controlled within a limited count, thereby improving the fingerprint enrollment efficiency and optimizing the use experience.

Although the embodiments of the present disclosure have been described above, the description is only used for the purpose of facilitating understanding of the present disclosure, and is not intended to limit the scope and application scenarios of the present disclosure. Any modification and variation in the form and details of the embodiments can be made by any person skilled in the art of the present disclosure without departing from the spirit and scope disclosed by the present disclosure. However, the scope of protection of the present disclosure is defined by the scope of the appended claims.

What is claimed is:

1. A method for fingerprint enrollment adapted to an electronic device including a display and a fingerprint sensor, the method comprising:
displaying a fingerprint enrollment interface on the display, wherein the fingerprint enrollment interface includes a progress indicator;
displaying, according to a swipe action of a finger detected by the fingerprint sensor, a growing progress of the progress indicator on the fingerprint enrollment interface; and
displaying, in response to the fingerprint sensor detecting that the finger is not removed, the progress indicator in a growing state on the fingerprint enrollment interface to represent that fingerprint information is being collected from the swipe action.

2. The method of claim 1, wherein the fingerprint enrollment interface includes one or more progress indicators; and
the method further comprises:
determining, according to whether each progress indicator displayed on the fingerprint enrollment interface is in a completed state, whether fingerprint enrollment of the finger is completed.

3. The method of claim 1, wherein the fingerprint enrollment interface further includes a background image displayed beneath the progress indicator; and
the displaying of the progress indicator in the growing state includes:
moving, in response to the growing progress of the progress indicator reaching a first preset threshold, the background image in a direction opposite to a growing direction of the progress indicator.

4. The method of claim 1, wherein the displaying of the growing progress of the progress indicator includes:
updating, according to a swipe speed or distance of the swipe action, a growing speed or length of the progress indicator displayed on the fingerprint enrollment interface.

5. The method of claim 1, further comprising
judging, in response to the fingerprint sensor detecting that the finger is removed, whether a single swipe action is valid or invalid; and
determining, according to whether a single valid swipe action or a plurality of valid swipe actions of each progress indicator meet a preset condition, whether each progress indicator is displayed in a completed state.

6. The method of claim 5, wherein the preset condition includes at least one of:
detecting that finger contact time reaches a first preset time length;
detecting that swipe distance reaches a first preset distance;
quality of the collected fingerprint information meeting a preset standard; or
a data amount of the collected fingerprint information reaching a second preset threshold.

7. The method of claim 5, further comprising:
displaying, in response to that a single valid swipe action does not meet the preset condition, a prompt message indicating that the swipe action is not completed on the fingerprint enrollment interface to prompt a user to perform more swipe actions.

8. The method of claim 5, wherein the judging whether the single swipe action is valid or invalid includes:
determining a single swipe action to be invalid in response to detecting any one of:
a false touch operation;
a finger contact time less than a second preset time length; or
a finger contact time greater than or equal to a third preset time length and a swipe distance less than a second preset distance; and otherwise, determining a single swipe action to be valid.

9. The method of claim 2, wherein the fingerprint enrollment interface includes a plurality of progress indicators configured to prompt a user to swipe with different areas of the finger; and
the method further comprises:
sequentially displaying the plurality of progress indicators on the fingerprint enrollment interface in a preset order; and
displaying, in response to a current progress indicator in a completed state displayed on the fingerprint enrollment interface, a next progress indicator on the fingerprint enrollment interface.

10. The method of claim 9, wherein the fingerprint enrollment interface includes three progress indicators on a left side, in a middle part and on a right side of the fingerprint enrollment interface respectively and configured to prompt the user to perform corresponding swipe actions with a left area, a middle area and a right area of the finger respectively.

11. The method of claim 1, wherein the fingerprint enrollment interface further includes an indication mark; and
the method further comprises:
displaying the indication mark at a forefront end of the progress indicator in the growing direction, to inform a user of a progress position of the progress indicator.

12. The method of claim 1, wherein the progress indicator is displayed as a progress bar.

13. The method of claim 1, wherein the fingerprint sensor is disposed at a position including at least one of:
beneath a screen of the display;
on a long edge of the display;
on a short edge of the display; or
on a back face of the display.

14. A computer-readable storage medium storing a program for fingerprint enrollment thereon which, when executed by a processor, causes the method of claim 1 to be performed.

15. An electronic device, comprising:
a fingerprint sensor configured to detect a swipe action of a finger;
a display configured to display a fingerprint enrollment interface, wherein the fingerprint enrollment interface includes a progress indicator; and
a processor connected to the fingerprint sensor and the display, respectively, and configured to:
display, according to the swipe action of the finger detected by the fingerprint sensor, a growing progress of the progress indicator on the fingerprint enrollment interface; and
display, in response to the fingerprint sensor detecting that the finger is not removed, the progress indicator in a growing state on the fingerprint enrollment interface to represent that fingerprint information is being collected from the swipe action.

16. The electronic device of claim 15, wherein the fingerprint enrollment interface includes one or more progress indicators; and
the processor is further configured to determine, according to whether each progress indicator displayed on the fingerprint enrollment interface is in a completed state, whether fingerprint enrollment of the finger is completed.

17. The electronic device of claim 15, wherein the fingerprint enrollment interface further includes a background image displayed beneath the progress indicator; and
the processor is further configured to move, in response to the growing progress of the progress indicator reaching a first preset threshold, the background image in a direction opposite to a growing direction of the progress indicator.

18. The electronic device of claim 15, wherein the processor is further configured to update, according to a swipe speed or distance of the swipe action, a growing speed or length of the progress indicator displayed on the fingerprint enrollment interface.

19. The electronic device of claim 15, wherein the processor is further configured to
judge, in response to the fingerprint sensor detecting that the finger is removed, whether a single swipe action is valid or invalid; and
determine, according to whether a single valid swipe action or a plurality of valid swipe actions of each progress indicator meet a preset condition, whether each progress indicator is displayed in a completed state.

20. The electronic device of claim 19, wherein the preset condition includes at least one of:
detecting that finger contact time reaches a first preset time length;
detecting that swipe distance reaches a first preset distance;
quality of the collected fingerprint information meeting a preset standard; or
a data amount of the collected fingerprint information reaching a second preset threshold.

21. The electronic device of claim 19, wherein the processor is further configured to display, in response to that a single valid swipe action does not meet the preset condition, a prompt message indicating that the swipe action is not completed on the fingerprint enrollment interface to prompt a user to perform more swipe actions.

22. The electronic device of claim 19, wherein the processor is further configured to determine a single swipe action to be invalid in response to detecting any one of:
a false touch operation;
a finger contact time less than a second preset time length; or
a finger contact time greater than or equal to a third preset time length and a swipe distance less than a second preset distance; and otherwise, determine a single swipe action to be valid.

23. The electronic device of claim 16, wherein the fingerprint enrollment interface includes a plurality of progress indicators configured to prompt a user to swipe with different areas of the finger; and
the processor is further configured to:
sequentially display the plurality of progress indicators on the fingerprint enrollment interface in a preset order; and
display, in response to a current progress indicator in a completed state displayed on the fingerprint enrollment interface, a next progress indicator on the fingerprint enrollment interface.

24. The electronic device of claim 23, wherein the fingerprint enrollment interface includes three progress indicators on a left side, in a middle part and on a right side of the fingerprint enrollment interface respectively and configured to prompt the user to perform corresponding swipe actions with a left area, a middle area and a right area of the finger respectively.

25. The electronic device of claim 15, wherein the fingerprint enrollment interface further includes an indication mark; and
the display is further configured to display the indication mark at a forefront end of the progress indicator in the growing direction, to inform a user of a progress position of the progress indicator.

26. The electronic device of claim 15, wherein the progress indicator is displayed as a progress bar.

27. The electronic device of claim 15, wherein the fingerprint sensor is disposed at a position including at least one of:
beneath a screen of the display;
on a long edge of the display;
on a short edge of the display; or
on a back face of the display.
